(19) United States
(12) Patent Application Publication
(10) Pub. No.: US 2004/0036964 A1
(43) Pub. Date: Feb. 26, 2004

(54) Lens module

(76) Inventors: Yin-Chan Huang, Taipei (TW); Bi-Chun Chen, Taipei (TW); Shu-Ya Chiang, Taipei (TW)

Correspondence Address: BIRCH STEWART KOLASCH & BIRCH, PO BOX 747, FALLS CHURCH, VA, 22040-0747, US

(21) Appl. No.: 10/645,509

(22) Filed: Aug. 22, 2003

(30) Foreign Application Priority Data
Aug. 22, 2002 (TW) 91118944

(51) Int. Cl. G02B 21/26

(52) U.S. Cl. 359/391

(57) ABSTRACT

A lens module includes a non-cylinder lens and a clamping apparatus. The clamping apparatus includes a base, two side parts, and a top part. Two side parts are disposed on two ends of the base to form a containing trough for holding the lens. One end of the top part is connected to one side part and the other end is fixed on the other side part. Two screw holes on the top part allow two adjusting screws to be screwed into for pressing the lens. Two elastic devices provide the elasticity between the lens and the base and the relative height of two sides of the lens is adjusted by turning the two adjusting screws.

This application claims the benefit of Taiwan application Serial No. 91118944, filed Aug. 22, 2002.

### BACKGROUND OF THE INVENTION

1. Field of the Invention

The invention relates in general to a lens module, and more particularly to a lens module including a non-cylinder lens and an apparatus for holding the non-cylinder lens.

2. Description of the Related Art

As technology develops and changes with each passing day, scanners have become indispensable equipment in people's lives. A scanner coupled with a computer can be used to scan documents or pictures, and the images captured by the scanner are stored in the hard discs of the computer for a further use. Moreover, the software installed in the computer can be used to process the scanned images to improve the quality of the scanned images, which is quite convenient.

A typical scanner at least includes a photoelectric sensing device and a light source. The photoelectric sensing device includes a mirror set, a lens module, and a light-sensing device. The lens module further includes a lens and a holding device for fastening the lens to the photoelectric sensing device. When the photoelectric sensing device scans a document step by step, first of all, the light source emits light to the document. Subsequently, the mirror set reflects the light reflected from the document into the lens. The lens passes the light and focuses the light onto the light-sensing device for forming an image. The light-sensing device captures the image in each scanning step. The whole image can be thus generated in the scanner as the photoelectric sensing device finishes scanning the whole document.

The lens is typically a cylindrical structure including a number of optical lenses. Since the light received by the lens passes through only the regions near the centers of the optical lenses, these optical lenses are not needed to be large. In particular, the design of the scanner is getting thinner and smaller. Accordingly, the shape of the lens in the lens module will be miniaturized to some other form, such as a triangle cone. However, the holding device for the cylinder lens will not satisfy the actual need for a non-cylinder lens any longer. Consequently, how to design a holding device for the non-cylinder lens is an obvious problem to be solved in the future.

### SUMMARY OF THE INVENTION

It is therefore an object of the invention to provide a lens module including a non-cylinder lens and a clamping apparatus. The extending parts of the lens and the corresponding grooves of the clamping apparatus make the clamping apparatus capable of clamping lens of any shape firmly. In addition, the slides on the lens and the corresponding grooves on the clamping apparatus or the grooves on the lens and the corresponding slides on the clamping apparatus can also make the clamping apparatus to clamp the lens of any shape firmly. Moreover, the elastic device providing the elasticity between the lens and the clamping apparatus is a shockproof design for the lens. Two adjusting screws help the user to adjust the relative height of two sides of the lens.

The invention achieves the above-identified objects by providing a lens module. The lens module includes a lens and a clamping apparatus. A first elastic device and a second elastic device are disposed beneath the lens and the clamping apparatus is installed in the photoelectric sensing device for clamping the lens to the photoelectric sensing device. The clamping apparatus includes a base, a first side part, a second side part, a top part, a first adjusting screw, and a second adjusting screw. The first side part and the second side part are respectively disposed on two ends of the base so that the first side part, the second side part, and the base form a containing trough for holding the lens. One end of the top part connects the top of the first side part and the other end is engaged with the top of the second side part. The top part includes a first screw hole and a second screw hole. The first adjusting screw and the second adjusting screw respectively go through the first screw hole and the second screw hole and press the two sides of the top of the lens to make the first elastic device and the second elastic device respectively touch the top of the base. The relative height of the two sides of the lens is adjusted by turning the first and the second adjusting screws.

Moreover, a first groove and a second groove can be respectively disposed on the two sides of the lens and a first slide and a second slide are respectively disposed on the inner sides of the first side part and the second side part for respectively engaging with the first groove and the second groove. Or a third slide and a fourth slide can be respectively disposed on the two sides of the lens, and a third groove and a fourth groove are respectively disposed on the inner sides of the first side part and the second side part for respectively engaging with the third slide and the fourth slide.

The invention achieves the above-identified objects by providing another lens module. The lens module includes a lens and a clamping apparatus. A first extending part and a second extending part are respectively disposed on two sides of the lens while a first elastic device and a second elastic device are respectively disposed beneath the first extending part and the second extending part. The clamping apparatus includes a base, a first side part, a second side part, a top part, a first adjusting screw, and a second adjusting screw. The first side part and the second side part are respectively disposed on each end of the base so that the first side part, the second side part, and the base form a containing trough for holding the lens. The inner sides of the first side part and the second side part respectively include a first groove and a second groove for engaging with the first extending part and the second extending part. A first screw hole and a second screw hole are respectively disposed on the upper surfaces of the first groove and the second groove. The top part includes one end connecting the top of the first side part where the other end is coupled with the top of the second side part. A first adjusting screw and a second adjusting screw are respectively screwed into the first screw hole and the second screw hole to press the first extending part and the second extending part and make the first elastic device and the second elastic device respectively to touch the lower surfaces of the first groove and the second groove. The relative height of the two sides of the lens is adjusted by turning the first and the second adjusting screws.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a lateral view of the lens module according to a first embodiment of the invention.

FIG. 2A is a perspective view of the lens in FIG. 1.

FIG. 2B is a top view of the lens in FIG. 2A.

FIG. 3 is a lateral view of the lens module according to a second embodiment of the invention

FIG. 4A is a perspective view of the lens in FIG. 3.

FIG. 4B is a top view of the lens in FIG. 4A.

### DETAILED DESCRIPTION OF THE INVENTION

The lens module in the invention is installed in the photoelectric sensing device of a scanner. The lens module includes a non-cylinder lens (such as a triangle cone lens), and a clamping apparatus for clamping the lens to the photoelectric sensing device. The practical application of the lens module according to the invention will be described in the following Example One and Example Two with reference to the accompanying drawings.

### EXAMPLE ONE

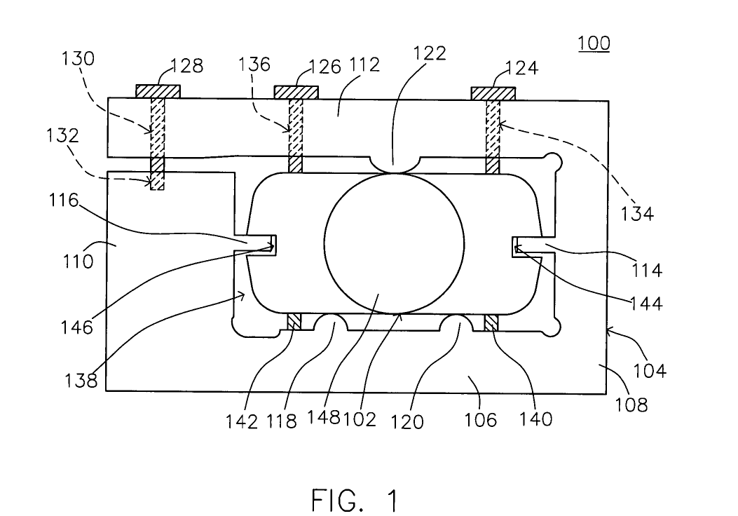

Referring to FIG. 1, a lateral view of the lens module according to the first embodiment in the invention is shown. In FIG. 1, the lens module 100 includes a lens 102 and a clamping apparatus 104. The clamping apparatus 104 is installed in a photoelectric sensing device (not shown) for clamping the lens 102 to the photoelectric sensing device so that the lens 102 can focus light to form images precisely.

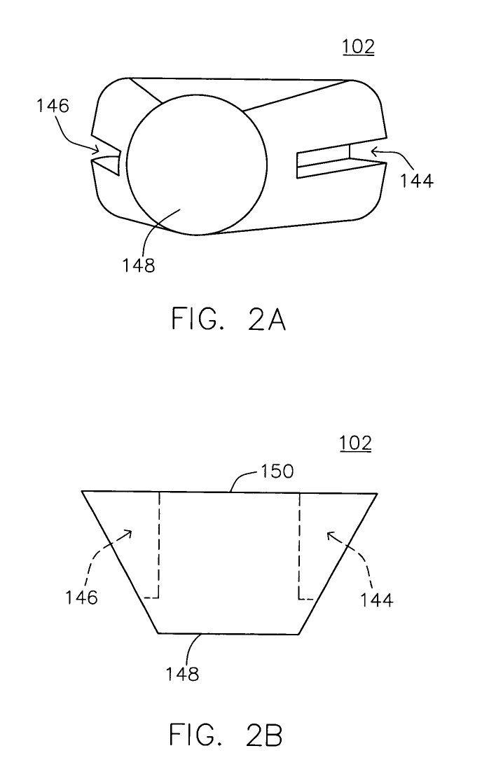

A first groove 144 and a second groove 146 are on two sides of the lens 102 respectively. The lens 102 includes a light-receiving end 148 as shown in FIG. 2A and FIG. 2B. In FIG. 2A, the lens 102 is shown to be a triangle cone. Certainly, as shown in FIG. 2B, the lens 102 also includes an image-forming end 150. Referring to FIG. 1, a first elastic device 140 and a second elastic device 142 are beneath the lens 102 and used for providing the elasticity between the lens 102 and the clamping apparatus 104 to prevent the lens 102 from being shocked.

The clamping apparatus 104 includes a base 106, a first side part 108, a second side part 110, a top part 112, a first adjusting screw 124, and a second adjusting screw 126. The first side part 108 and the second side part 110 are respectively disposed on two ends of the base 106 so that the first side part 108, the second side part 110, and the base form a containing trough 138 for holding the lens 102.

The inner sides of the first side part 108 and the second side part 110 respectively include a first slide 114 and a second slide 116 for engaging with the first groove 144 and the second groove 146 as the lens 102 is set into the containing trough 138.

The top part 112 includes one end connected to the top of the first side part 108 and the other end coupled with the top of the second side part 110. For example, the top of the second side part 110 includes a fixing hole 132 and the top part 112 includes an opening 130 corresponding to the fixing hole 132. A screw 128 goes through the opening 130 and is screwed into the fixing hole 132 so that the top part 112 can be fixed on the top of the second side part 110. Moreover, the top part 112 includes a first screw hole 134 and a second screw hole 136. The base 106, the first side part 108, the first slide 114, the second side part 110, the second slide 116, and the top part 112 can be formed as a unity.

The first adjusting screw 124 and the second adjusting screw 126 are respectively screwed into the first screw hole 134 and the second screw hole 136. The first adjusting screw 124 and the second adjusting screw 126 are respectively vertically opposing to the first elastic device 140 and the second elastic device 142. The first adjusting screw 124 and the second adjusting screw 126 respectively press the two sides of the top of the lens 102 to make the first elastic device 140 and the second elastic device 142 touch the top of the base 106 so that the elasticity is provided between the lens 102 and the base 106.

The first adjusting screw 124 and the second adjusting screw 126 can be further respectively turned in the first screw hole 134 and the second screw hole 136 to adjust the relative height of the two sides of the lens 102.

However, one who is skilled in the art will understand that the technique in the invention is not limited to the example disclosed above. For example, the first elastic device 140 and the second elastic device 142 can be springs or any other elastic structure. The first elastic device 140 and the second elastic device 142 can be also disposed on the top of the lens 102 to provide the elasticity between the lens 102 and the base 106.

At least one raised portion can be projected from the top of the base 102 such as the raised portions 118, 120 for touching the bottom of the lens 102 and at least one raised portion can be projected from the bottom of the top part 112 such as the raised portion 122 for touching the top of the lens 102, both of which help to hold the lens 102 tightly. In addition, the width of the first groove 114 and the width of the second groove 116 are respectively larger than the thickness of the first slide 144 and the thickness of the second slide 146.

In the invention the roles of the groove on the lens 102 and the slide on the clamping apparatus 104 can even be exchanged. For example, the two sides of the lens 102 respectively include a third slide and a fourth slide while the inner sides of the first side part 108 and the second side part 110 respectively include a third groove and a fourth groove for respectively engaging with the third slide and the fourth slide. Moreover, the width of the first groove 114 and the width of the second groove 116 are respectively larger than the thickness of the first slide 144 and the thickness of the second slide 146.

### EXAMPLE TWO

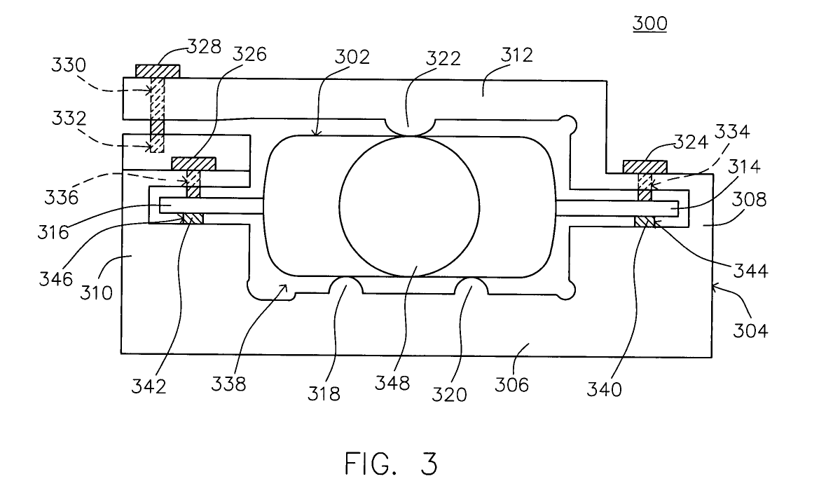

Referring to FIG. 3, a lateral view of the lens module according to the second embodiment in the invention is shown. In FIG. 3, the lens module 300 includes a lens 302 and a clamping apparatus 304. The clamping apparatus 304 is installed in a photoelectric sensing device (not shown) for clamping the lens 302 to the photoelectric sensing device so that the lens 302 can focus light to form images precisely.

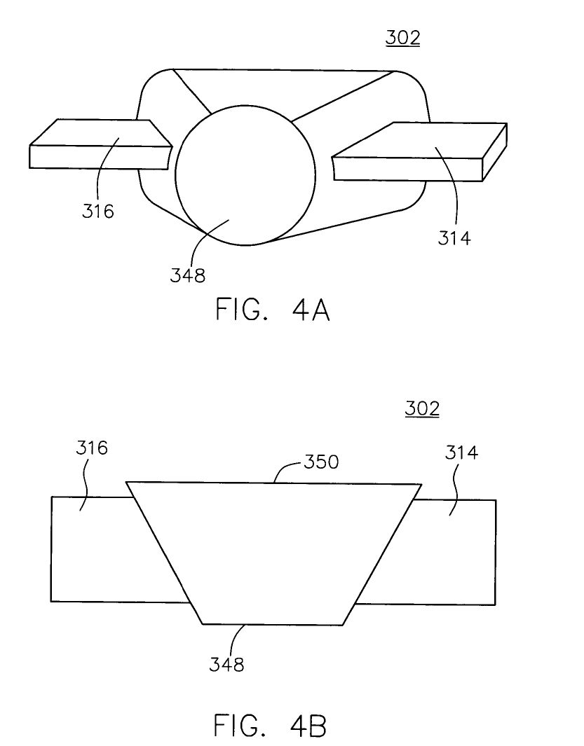

A first extending part 314 and a second extending part 316 are on two sides of the lens 302 respectively. The lens 302 includes a light-receiving end 348 as shown in FIG. 4A and FIG. 4B. In FIG. 4A, the lens 302 is shown to be a triangle cone. Certainly, as shown in FIG. 4B, the lens 102 also includes an image-forming end 350. Referring to FIG. 3, a first elastic device 340 and a second elastic device 342 are beneath the lens 302 and used for providing the elasticity between the lens 302 and the clamping apparatus 304 to prevent the lens 102 from being shocked.

The clamping apparatus 304 includes a base 306, a first side part 308, a second side part 310, a top part 312, a first adjusting screw 324, and a second adjusting screw 326. The first side part 308 and the second side part 310 are respectively disposed on two sides of the base 306 so that the first side part 308, the second side part 310, and the base form a containing trough 338 for holding the lens 302.

The inner sides of the first side part 308 and the second side part 310 respectively include a first groove 344 and a second groove 346 for engaging with the first extending part 314 and the second extending part 316 as the lens 302 is set into the containing trough 338.

The top part 312 includes one end connected to the top of the first side part 308 and the other end coupled with the top of the second side part 310. For example, the top of the second side part 310 includes a fixing hole 332 and the top part 312 includes an opening 330 corresponding to the fixing hole 332. A screw 328 goes through the opening 330 and is screwed into the fixing hole 332 so that the top part 312 is fixed on the top of the second side part 310. Moreover, the top part 312 includes a first screw hole 334 and a second screw hole 336. The base 306, the first side part 308, the first slide 314, the second side part 310, the second slide 316, and the top part 312 can be formed as a unity. It is noted that the second adjusting screw 326 and the screw 328 are not located on the same vertical cross-section and the second adjusting screw 326 is closer to the light-receiving end 348 of the lens 302 than the screw 328.

The first adjusting screw 324 and the second adjusting screw 326 are respectively screwed into the first screw hole 334 and the second screw hole 336. The first adjusting screw 324 and the second adjusting screw 326 are respectively vertically opposing to the first elastic device 340 and the second elastic device 342. The first adjusting screw 324 and the second adjusting screw 326 respectively press the first extending part 314 and the second extending part 316 to make the first elastic device 340 and the second elastic device 342 respectively to touch the lower surfaces of the first groove 344 and the second groove 346 so that the elasticity is provided between the lens 302 and the clamping apparatus 304.

The first adjusting screw 324 and the second adjusting screw 326 can be further respectively turned in the first screw hole 334 and the second screw hole 336 to adjust the relative height of the two sides of the lens 302.

However, one who is skilled in the art will understand that the technique in the invention is not limited to the example disclosed above. For example, the first elastic device 340 and the second elastic device 342 can be springs or any other elastic structure. The first elastic device 340 and the second elastic device 342 can be also respectively disposed on the lower surfaces of the first groove 344 and the second groove 346 to provide the elasticity between the lens 302 and the clamping apparatus 304.

At least one raised portion can be projected from the top of the base 302 such as the raised portions 318, 320 for touching the bottom of the lens 302 and at least one raised portion can be projected from the bottom of the top part 312 such as the raised portion 322 for touching the top of the lens 302, both of which help to hold the lens 302 tightly. In addition, the width of the first groove 344 is larger than the total height of the first extending part 314 and the first elastic device 340 and the width of the second groove 346 is larger than the total height of the second extending part 316 and the second elastic device 342.

The advantages of the lens module according to the invention are as follows:

1. The extending parts of the lens and the corresponding grooves of the clamping apparatus make the clamping apparatus capable of clamping the lens of any shape firmly.

2. The slides of the lens and the corresponding grooves of the clamping apparatus or the grooves of the lens and the corresponding slides of the clamping apparatus make the clamping apparatus capable of clamping lens of any shape firmly.

3. The elastic devices provide the elasticity between the lens and the clamping apparatus to prevent the lens from being shocked.

4. Two adjusting screws help to adjust the relative height of the two sides of the lens.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A lens module, comprising:
a lens, wherein a first elastic device and a second elastic device are disposed beneath the lens; and
a clamping apparatus, disposed in a photoelectric sensing device for clamping the lens to the photoelectric sensing device, the clamping apparatus comprising:
a base;
a first side part and a second side part, respectively disposed on two sides of the base, wherein the first side part, the second side part, and the base form a containing trough for holding the lens;
a top part, having one end connected to a top of the first side part and the other end coupled with a top of the second side part, the top part comprising a first screw hole and a second screw hole; and
a first adjusting screw and a second adjusting screw, respectively screwed into the first screw hole and the second screw hole, for pressing two sides of the lens to make the first elastic device and the second elastic device to touch the top of the base;
wherein the relative height of the two sides of the lens is adjusted by turning the first adjusting screw and the second adjusting screw.

2. The lens module according to claim 1, wherein the first elastic device and the second elastic device are springs.

3. The lens module according to claim 1, wherein at least one raised portion is projected from the top of the base for touching the bottom of the lens.

4. The lens module according to claim 1, wherein at least one raised portion is projected from the bottom of the top part for touching the top of the lens.

5. The lens module according to claim 1, wherein the top of the second side part has a fixing hole, the top part has an opening corresponding to the fixing hole, and a screw goes through the opening to be screwed into the fixing hole in order to fix the top part on the top of the second side part.

6. The lens module according to claim 1, wherein a first groove and a second groove are respectively disposed on the two sides of the lens, and a first slide and a second slide are respectively disposed on the inner sides of the first side part and the second side part for engaging with the first groove and the second groove.

7. The lens module according to claim 6, wherein the width of the first groove and the width of the second groove are respectively larger than the thickness of the first slide and the thickness of the second slide.

8. The lens module according to claim 1, wherein a third slide and a fourth slide are respectively disposed on the two sides of the lens, and a third groove and a fourth groove are respectively disposed on the inner sides of the first side part and the second side part for engaging with the third slide and the fourth slide.

9. The lens module according to claim 8, wherein the width of the third groove and the width of the fourth groove are respectively larger than the thickness of the third slide and the thickness of the fourth slide.

10. The lens module according to claim 1, wherein the first adjusting screw and the second adjusting screw are respectively vertically opposing to the first elastic device and the second elastic device.

11. A lens module, comprising:
a lens, wherein a first extending part and a second extending part are respectively disposed on two sides of the lens, and a first elastic device and a second elastic device are respectively disposed beneath the first extending part and the second extending part; and
a clamping apparatus, installed in a photoelectric sensing device for clamping the lens to the photoelectric sensing device, the clamping apparatus comprising:
a base;
a first side part and a second side part, respectively disposed on two sides of the base, wherein the first side part, the second side part, and the base form a containing trough for holding the lens, the first side part and the second side part respectively comprising a first groove and a second groove for containing the first extending part and the second extending part, and the upper surfaces of the first groove and the second groove respectively comprising a first screw hole and a second screw hole;
a top part, having one end connected to a top of the first side part and the other end coupled with a top of the second side part; and
a first adjusting screw and a second adjusting screw, respectively screwed into the first screw hole and the second screw hole, for pressing the first extending part and the second extending part to make the first elastic device and the second elastic device respectively touch the lower surfaces of the first groove and the second groove;
wherein the relative height of the two sides of the lens is adjusted by turning the first adjusting screw and the second adjusting screw.

12. The lens module according to claim 11, wherein the first elastic device and the second elastic device are springs.

13. The lens module according to claim 11, wherein at least one raised portion is projected from the top of the base for touching the bottom of the lens.

14. The lens module according to claim 11, wherein at least one raised portion is projected from the bottom of the top part for touching the top of the lens.

15. The lens module according to claim 11, wherein the top of the second side part has a fixing hole, and the top part has an opening corresponding to the fixing hole, and a screw goes through the opening to be screwed into the fixing hole in order to fix the top part on the top of the second side part.

16. The lens module according to claim 11, wherein the width of the first groove is larger than the total height of the first extending part and the first elastic device, and the width of the second groove is larger than the total height of the second extending part and the second elastic device.

17. The lens module according to claim 11, wherein the first adjusting screw and the second adjusting screw are respectively vertically opposing to the first elastic device and the second elastic device.

18. A scanner, including a photoelectric sensing device, wherein the photoelectric sensing device at least comprises:
a lens, wherein a first extending part and a second extending part are respectively disposed on two sides of the lens, and a first elastic device and a second elastic device are respectively disposed beneath the first extending part and the second extending part; and
a clamping apparatus for clamping the lens, the clamping apparatus comprising:
a base;
a first side part and a second side part, respectively disposed on two sides of the base, wherein the first side part, the second side part, and the base form a containing trough for holding the lens, the first side part and the second side part respectively having a first groove and a second groove for engaging with the first extending part and the second extending part, the upper surfaces of the first groove and the second groove respectively having a first screw hole and a second screw hole;
a top part, having one end connected to a top of the first side part and the other end coupled with a top of the second side part; and
a first adjusting screw and a second adjusting screw, respectively screwed into the first screw hole and the second screw hole, for pressing the first extending part and the second extending part to make the first elastic device and the second elastic device respectively touch the lower surfaces of the first groove and the second groove;
wherein the relative height of the two sides of the lens is adjusted by turning the first adjusting screw and the second adjusting screw.

19. The lens module according to claim 18, wherein the first elastic device and the second elastic device are springs.

20. The lens module according to claim 18, wherein the top of the second side part has a fixing hole, the top part has an opening corresponding to the fixing hole and a screw goes through the opening to be screwed into the fixing hole in order to fix the top part on the top of the second side part.
